(19) United States
(12) Patent Application Publication
(10) Pub. No.: US 2004/0019636 A1
(43) Pub. Date: Jan. 29, 2004

(54) System and method for dynamically routing web procedure calls

(75) Inventors: Robert P. St. Pierre, Sunnyvale, CA (US); Glenn C. Scott, Mountain View, CA (US)

Correspondence Address: LAHIVE & COCKFIELD, 28 STATE STREET, BOSTON, MA, 02109, US

(73) Assignee: Sun Microsystems, Inc., Santa Clara, CA (US)

(21) Appl. No.: 10/206,932

(22) Filed: Jul. 24, 2002

(51) Int. Cl. G06F 15/16

(52) U.S. Cl. 709/203

(57) ABSTRACT

A method for dynamically routing web procedure calls is disclosed. A “web procedure call” refers to any interaction between two devices or services in network environment where the calling party requests some activity by the called party (e.g., to accept data or perform a specific task). When a user requests a service from a server, and the request fails due to the server's unavailability or inability to complete a request, a dynamic routing approach is initiated. A “look up” service finds an alternate server that provides the same service as that which was requested. The device dynamically routes the service request to the alternate server and the request is processed. The alternate server returns the response of the request to the device. The client can determine the desired format of the return data using MIME encoding. A present invention also discloses a method for an abstract service. The abstract service enables a service request to refer to a service symbol such as the name of service (such as “stock quote”) or attribute of the service rather than to refer to the address of the server that provides the service. The electronic device dynamically discovers the service access point for the service and returns the URL of the server that provides the requested service.

### FIELD OF THE INVENTION

The illustrative embodiment of the present invention relates generally to software and more particularly to dynamic routing of the web procedure calls.

### RELATED APPLICATIONS

The illustrative embodiment of the present invention is related to four co-pending applications, A System and Method For Processing Callback Requests Included in Web-Based Procedure Calls, A System and Method For Processing Callback Requests Included in Web-Based Procedure Calls Through a Firewall, MIME Encoding of Values for Web Procedure Calls, and A System and Method for Forward Chaining Web-Based Procedure Calls filed concurrently with the present application.

### BACKGROUND OF THE INVENTION

The Hypertext Transfer Protocol (HTTP) is a popular transport protocol that is employed on the Internet. HTTP is used for transport of resources, such as HTML files, image files, and query results. Each resource is identified by a Uniform Resource Locator (URL). An example of a URL is http://www.sun.com, which identifies the home page of a web site for Sun Microsystems, Inc. The most common kind of resource is a file, but a resource may be a dynamically generated query result or the output of a CGI script.

In a typical interaction on the Internet, a “client” requests service from a “server”. The client specifies the server by an URL. The client submits a request (such as for a web page) and receives a response back from the server.

There are a number of drawbacks to the approach of requiring the client to possess knowledge of the location of the service. First, sometimes the service is unavailable so the request for service fails. Second, sometimes a user may not know the location of the service and may need to conduct a search to discover the location of the service. This is time-consuming and often times there are inordinate number of hits in the search results that the user must evade through to find the desired service.

### SUMMARY OF THE INVENTION

The illustrative embodiment of the present invention provides a mechanism for dynamically routing a web procedure call. A “web procedure call” refers to any interaction between two devices or services in network environment where the calling party requests some activity by the called party (e.g., to accept data or perform a specific task). For example, service A can request a service to service B in a web procedure call and service B can return the result to service A via a web procedure call using the callback mechanism.

In accordance with one aspect of the present invention, a method is practiced in an electronic device to provide an abstract service. The abstract service enables a service request to refer to a service symbol such as the name of service (such as “stock quote”) or an attribute, rather than to refer to the address of the server that provides the service. The electronic device dynamically discovers the service access point for the service and returns the URL of the server that provides the requested service. The service request is processed by the discovered server, and a response to the request is returned to the electronic device.

In accordance with another aspect of the present invention, a method is practiced in an electronic device for dynamic routing. When a user requests a service from a server, and the request fails due to the server's unavailability, a dynamic routing approach is initiated. A “look up” service finds an alternate server that provides the same service as that which was requested. Next, the device dynamically routes the service request to the alternate server and the request is processed. Lastly, the alternate server returns the response of the request to the device.

In another embodiment, a flexible format for returned data is supported. This embodiment allows the client to specify the desired format of the data in response to a request from a server.

In another embodiment, MIME is used as the data encoding scheme. The benefits of using MIME encoding and decoding rather than using XML include avoiding the heavyweight parse engines of XML.

### BRIEF DESCRIPTION OF THE DRAWINGS

FIG. 1 depicts a block diagram of a conventional client/server environment for web procedure calls;

FIG. 2 depicts a block diagram of a client/server environment suitable for dynamic routing of the present invention;

FIG. 3 depicts a flow chart illustrating the steps that are performed in the dynamic routing of illustrative embodiment;

FIG. 4 depicts a block diagram of client/server environment suitable for abstract service of the present invention; and

FIG. 5 depicts a flow chart illustrating the steps that are performed in the abstract service of illustrative embodiment.

### DETAILED DESCRIPTION OF THE INVENTION

The illustrative embodiment of the present invention provides a mechanism for dynamically routing web procedure calls. Dynamic routing refers to determining what server to route a request for service at the time that the request is made. Services are represented as abstractions known as abstract services. A client request gets dynamically resolved to a particular server. This eliminates the problem of unavailability of a server by allowing the request to be redirected to an alternate server that is available.

The illustrative embodiment of the present invention contains a set of libraries on both the client and the server side Application Program Interface (APIs). These libraries provide four major features. The first feature is the dynamic discovery of service access points. The second feature is dynamic routing to find an alternate service when the originally requested service is unavailable. The third feature is flexibility in the format of data returned to a client by a service. The fourth feature is the efficient encoding of data using MIME. Each of these four major features will be described in more detail in below.

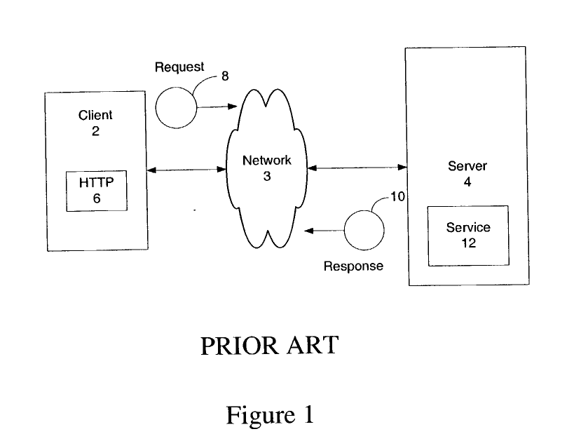

FIG. 1 depicts a block diagram of a client/server environment suitable for a conventional method for the processing of a web procedure call. A network 3, such as the Internet, is interfaced with a web server 4. The web server 4 is an electronic device that delivers web pages to clients and provides web services to clients. In FIG. 1, the web server 4 provides a web service 12 to clients. An electronic device 2 is also interfaced with the network 3. The electronic device 2 may be, for examples, a desktop computer system, workstation system, PDA, handheld wireless device, laptop computer, cellular phone or other device interfaced with the network 3. The devices may be physically connected or connected using wireless technology. The electronic device 2 includes HTTP support 6.

A transaction is initiated when a connection is established over the network 3 between the client 2 and the server 4. The client 2 sends an HTTP request 8 to the server 4. The request 8 contains a URL for the server 4. The server 4 receives the request 8 and sends an HTTP response 10 back to the client 2 over the open connection. Thus, for example, the client 2 requests a web page that is returned from the server 4 to the client 2.

For this conventional approach, there is a problem when the device can't make a connection with the server or the specific service is unavailable. The client is left with no alternative but to try again later.

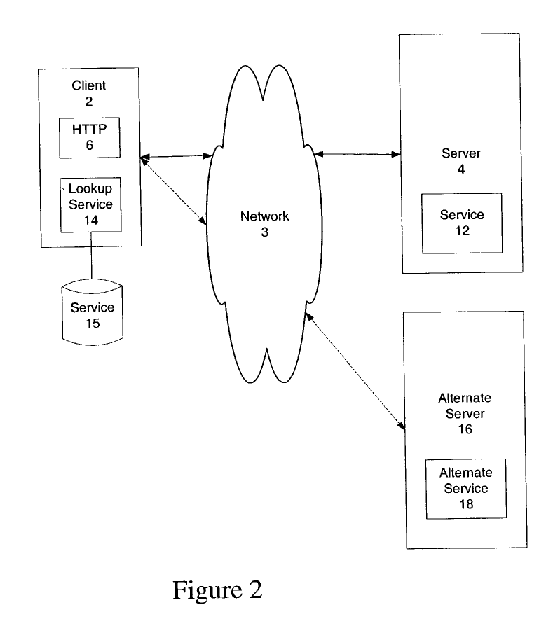

FIG. 2 depicts a block diagram of an environment suitable for practicing the illustrative embodiment of the present invention. For example, client initiates an HTTP GET request, which is sent from the client 2 to the server 4 through the network 3. The GET retrieves information (in the form of an entity) that is identified by a Request-Uniform Resource Identifier (URI) (which is a more generalized version of a URL). The Request-URI is a parameter that is provided by the client. The server responds by returning the requested information in a response 10 that is returned to the client 2 over the network 3.

Sometimes, the request to the server fails due to various reasons. In such cases, the server may send any of a variety of response status codes that identify the type of error to the client. For example, there may be an internal server error that prevents the server from fulfilling the request. The “Internal Server Error” response status code (HTTP) is sent to a client when the server encounters an unexpected condition, which prevents the server from fulfilling the request. The server also might not support the functionality required to fulfill the request. The “Not Implemented” response status code (HTTP) is sent to a client when the server does not recognize the request method and is not capable of supporting the request. The “Service Unavailable” response status code (HTTP) is sent to a client when the server is currently unable to handle the request. For example, the “Service Unavailable” response status code (HTTP) may be generated due to a temporary overloading of the server or due to maintenance being performed on the server. Sometimes, the server requires the same HTTP protocol version that was used in the request message. The “HTTP Version Not Supported” response status code is sent to a client when the server does not support the HTTP protocol version used by a client. The server indicates that the server is unable to complete the request using the same version of the HTTP protocol as the client. Additionally, the request to the server may fail by timing out without either a success or error response being returned. This type of error may occur due to a server failure or network outage such as a routing problem or network partitioning.

When the request is not fulfilled due to an error, the “look up” service 14 is invoked. The “look up” service 14 finds an alternate server 16 that provides an alternate service 18. The alternate service 18 provides the same service as an original service 12 and returns the same result.

The Service Location Protocol (SLP) is used in the illustrative embodiment of the present invention for “look up” service to find an alternate server but the “look up” service can be implemented using other protocols such as Lightweight Directory Access Protocol (LDAP), DNS SRV records or other service discovery protocol.

The SLP is a protocol established by the Internet Engineering Task Force (IETF) that simplifies the discovery of network resources. The protocol utilizes the concept of User Agents, Service Agents and Directory Agents. Applications running on a computer are represented by User Agents which understand the service and resource needs of the application. In the case of the present invention, a client 2 is represented by a User Agent. Each network server is represented by a Service Agent. Some networks have Directory Agents. The Service Agent sends out a multicast request for any Directory Agents on the network to make contact. If any Directory Agents respond, the Service Agent sends a registration unicast to each responding Directory Agent. The registration unicast includes the type of server the Service Agent is representing, the server's attributes, and the server's Uniform Resource Locator (URL) address. When a User Agent needs a particular service, it sends out a service request which includes both the type of service and attributes desired. If the network possesses a Directory Agent, the Directory Agent responds with a list of eligible servers and the servers Uniform Resource Locator (URL) address. If there is no Directory Agent on the network, the User Agent multicasts its service request on the network and the Service Agents for devices whose attributes match those requested respond directly to the User Agent.

After finding an alternate server 16, the request is sent to the alternate server 16 for service. The alternate service 18 on the alternate server 16 processes the request and returns the data. The process is completed when the request is fulfilled. Otherwise, the dynamic routing process is repeated until the client gets the result of request.

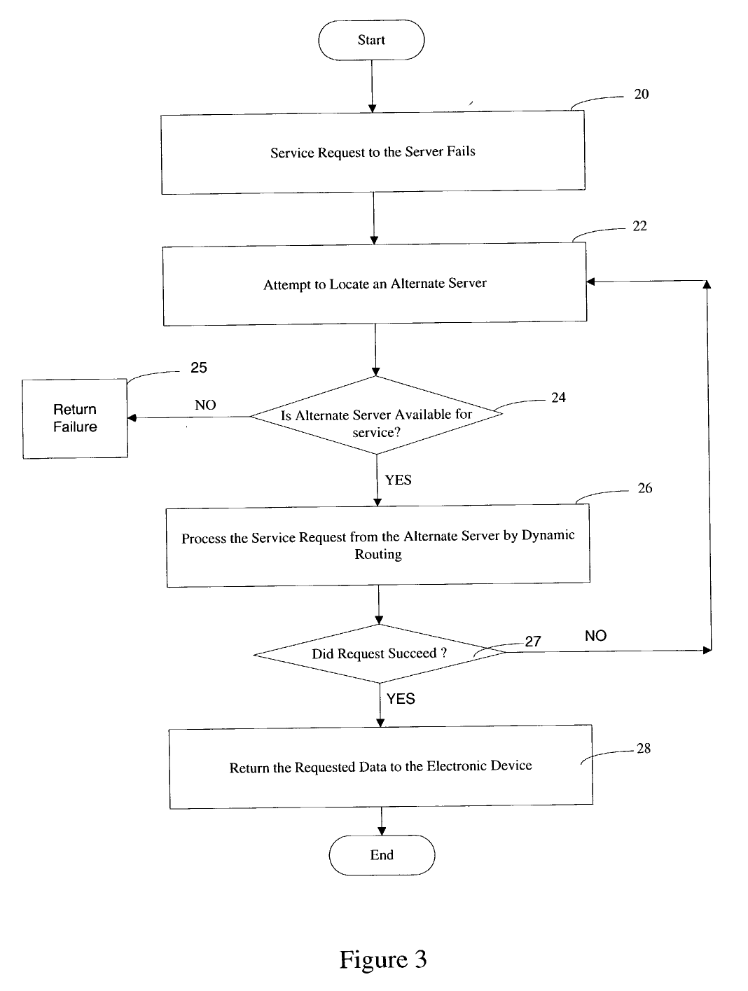

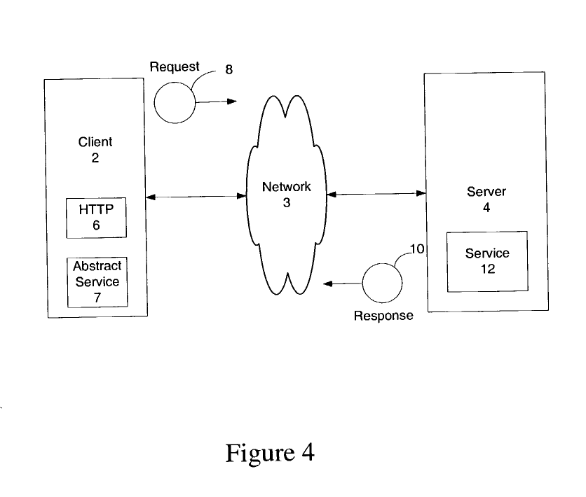

FIG. 3 depicts a flow chart illustrating the steps that are performed in the dynamic routing performed in the illustrative embodiment of the present invention. When a service request to the server fails, the “look up” service finds an alternate server that provides the identical result based on the characteristics of the service (step 22 of FIG. 4). The alternate server is checked for availability (step 24). If an alternate server is not available, a return failure message is delivered (step 25). If an alternate server is available, the “look up” service finds another server that provides the same service. When the available alternate server is found, the electronic device 2 is connected to the alternate server by dynamic routing and the server processes the web procedure call (step 26). If the service request processing is successful (step 27) the alternate server returns the requested data to the electronic device (step 28). If the service request processing is unsuccessful (step 27) the sequence returns to attempting to locate an alternate server (step 22).

The illustrative embodiment of the present invention provides an abstract service. Conventionally, a client connects to a service by knowing the specific network address and protocol information about the server (such as URL). Specifically, the applications of the client must specify the address and port number of the service. The abstract service allows the applications to request a service by including a service symbol in the request. The service symbol may be the name of the service (i.e., stock quote), an attribute of the service, or some other reference to the desired service, rather than the address and protocol used by the service. The service symbol is then translated into a request for the appropriate service at a specific address and port number.

FIG. 4 depicts a block diagram of an environment suitable for practicing the illustrative embodiment of the abstract service of the present invention. The abstract service 7 dynamically discovers the service endpoint and returns that service information in the form of an URL. The URL contains the necessary address and protocol information for contacting the server 4 from the device. The protocol may be HTTP, FTP or SMTP or some other protocol. Alternatively, the protocol may be a transaction-based protocol such as remote copy (rcp) or tftp (trivial file transport protocol). The SLP is used in the illustrative embodiment of the present invention for the abstract service to discover the service endpoint but the abstract service can be implemented using other protocols such as Lightweight Directory Access Protocol (LDAP), DNS SRV records or other service discovery mechanisms.

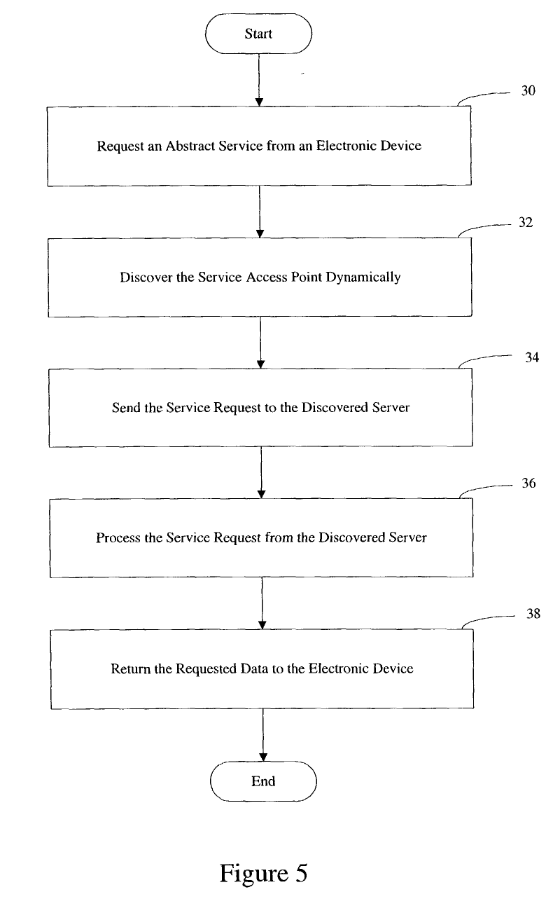

FIG. 5 depicts a flow chart illustrating the steps that are performed in the abstract service of the illustrative embodiment of the present invention. Initially, the user requests an abstract service from an electronic device (step 30 of FIG. 5). The user can enter the abstract service name (i.e., stock quote or weather) rather then the specific web address. The abstract service 7 finds the service access point dynamically (step 32). The abstract service provides the service endpoint by the form of the URL. The electronic device 2 sends the service request to the discovered server 4 (step 34). For illustrative example of the stock quote, the request message contains a symbol of stock (such as SUN), a type of the service (such as real-time), and the web address of the server (such as www.stocks.com). The server 4 processes the request of the web procedure call (step 36). Lastly, the server 4 returns the requested data to the electronic device (step 38). Those skilled in the art will recognize that the present invention may initiate the abstract service request programmatically without the participation of a user.

One advantage of the abstract service of the illustrative embodiment is that the user does not need to remember the specific URL for the service. The illustrative embodiment of the present invention will find a service based on the user's abstract requests such as stock quote, weather, sport game score and etc. Additionally, if the user has requested an unavailable instance of the server, such as an unavailability due to a server outage, the system as described can locate an available alternative server.

The illustrative embodiment of the present invention provides a flexible format for the return data. A flexible return format allows a client to specify the desired format of the return information since clients may have the different limitations based on their systems such as a Web browser, an application, embedded services and etc. The return data is MIME encoded and puts in the body of the response. The individual data elements of the return data may be arbitrary types by using the multipart MIME message. The user can specify the individual data elements of the return data to be x-value/integer, x-value/string, text/plain, text/html and etc. The format list above is only for the illustrative purpose and many other formats are possible depending on the designer's implementation.

The illustrative embodiment of the present invention provides a method of providing a web procedure call by using a MIME encapsulation for data to be passed between entities in a network. The benefits of using MIME encoding and decoding rather than using XML include avoiding the heavyweight parse engines of XML. For most of client-server or peer-to-peer operation, XML can be overkill and waste of resources such as a CPU and the Memory to parse the XML's complex document structure.

An advantage of MIME encoding scheme is that it is easily transferred over both Hyper Text Transfer Protocol (HTTP) and Simple Mail Transfer Protocol (SMTP) for both interactive service, and store and forward based service. HTTP defines how messages are formatted, and what action Web servers and browsers should take in response to various commands. SMTP is a protocol for sending e-mail messages between servers. Most e-mail systems that send mail over the Internet using SMTP to send messages from one server to another.

Another advantage of MIME encoding scheme compare to XML scheme is that MIME already provides many predefined and well understood data types such as text/plain and image/jpg.

It will thus be seen that the invention efficiently attains the objects made apparent from the preceding description. Since certain changes may be made without departing from the scope of the present invention, it is intended that all matter contained in the above description or shown in the accompanying drawings be interpreted as illustrative and not in a literal sense. The description and illustrations shall not be construed as limiting the invention. Rather, it is intended that the invention be limited only to the extent required by the appended claims and the applicable rules of law. Practitioners of the art will realize that the network configurations depicted and described herein are examples of the multiple possible network configurations that fall within the scope of the current invention.

We claim:

1. In an electronic device interfaced with a network, wherein the network includes at least two servers providing a type of service, a method comprising the electronic device implemented steps of:
receiving a request for an abstract service, said request including a service symbol,
upon receiving the request, dynamically resolving the service symbol to a service provider on a selected one of the servers; and
submitting a request to the service provider on the selected server.

2. The method of claim 1 wherein said service symbol is at least one of an attribute and a service name.

3. The method of claim 1, wherein the step of dynamically resolving the service name is performed using the Service Location Protocol (SLP).

4. The method of claim 1, wherein the step of dynamically resolving the service name is performed using the Lightweight Directory Access Protocol (LDAP).

5. The method of claim 1, wherein the step of dynamically resolving the service name is performed using DNS SRV records.

6. The method of claim 1, further comprising the step of providing the electronic device with an URL of the selected server, said URL containing the necessary address and protocol information regarding a protocol to be used in communicating with the selected server.

7. The method of claim 6, wherein the protocol is at least one of HTTP (Hypertext Transfer Protocol), FTP (File Transport Protocol), and (SMTP Simple Mail Transport Protocol).

8. The method of claim 6 wherein the protocol is a transaction based protocol.

9. In an electronic device interfaced with a network, wherein the network includes at least two servers providing a type of service, a method comprising the electronic device implemented steps of:
submitting a first request for the type of service to a first of the servers;
determining that the request failed; and
in response to determining that the request failed, programmatically identifying a second of the servers that provides the type of service and submitting a second request for the type of service to a second of the server.

10. The method of claim 9, wherein the the type of service is identified by a service name.

11. The method of claim 9, further comprising the step of:
locating the first of the servers and the second of the servers, wherein said locating is realized through the use of the Service Location Protocol (SLP).

12. The method of claim 9, further comprising the step of:
locating the first of the servers and the second of the servers, wherein said locating is realized through the use of the Lightweight Directory Access Protocol (LDAP).

13. The method of claim 9, further comprising the step of:
locating the first of the servers and the second of the servers wherein said locating is realized through use of DNS SRV records.

14. The method of claim 9, further comprising the step of:
determining an URL of the second server, said URL containing the address and protocol information for communicating with the second server.

15. The method of claim 14, wherein the protocol is at least one of HTTP (Hypertext Transfer Protocol), FTP (File Transport Protocol), and (SMTP Simple Mail Transport Protocol).

16. The method of claim 14 wherein the protocol is a transaction based protocol.

17. In an electronic device interfaced with a network, wherein the network includes multiple servers providing a type of service, a method comprising the electronic device implemented steps of:
receiving an initial request for the type of service wherein the initial request identifies the type of service by service name;
determining a desired format for return data;
upon receiving the initial request, dynamically resolving the service name to a selected one of the servers; and
submitting a submitted request for the type of service to the selected server.

18. The method of claim 17, wherein the return data is encoded in MIME.

19. In an electronic device interfaced with a network, wherein the network includes at least two servers providing a type of service, a method comprising the electronic device implemented steps of:
providing a MIME data encoding when a web procedure call is made between the electronic device and a server;
receiving a request for the type of service wherein the request identifies the type of service by service name;
upon receiving the request, dynamically resolving the service name to a selected one of the servers; and
submitting a submitted request for the type of service to the selected server.

20. A medium for use in an electronic device interfaced with a network, wherein the network includes at least two servers providing a type of service, said medium holding instructions for performing a method, said method comprising the steps of:
receiving a request for the type of service wherein the request identifies the type of service by a service symbol, said symbol being at least one of a service name and an attribute;
upon receiving the request, dynamically resolving the service symbol to a service provider on a selected one of the servers; and
submitting a request to the service provider on the selected server.
